(19) United States
(12) Patent Application Publication
(10) Pub. No.: US 2009/0039658 A1
(43) Pub. Date: Feb. 12, 2009

(54) VEHICLE DOOR LATCH SYSTEM

(76) Inventor: Nigel Victor Spurr, Solihull (GB)

Correspondence Address: CARLSON, GASKEY & OLDS, P.C., 400 WEST MAPLE ROAD, SUITE 350, BIRMINGHAM, MI, 48009, US

(21) Appl. No.: 12/173,298

(22) Filed: Jul. 15, 2008

(30) Foreign Application Priority Data
Aug. 11, 2007 (GB) 0715710.0

(51) Int. Cl. E05B 3/00

(52) U.S. Cl. 292/336.3

(57) ABSTRACT

An electronic door lock system for a vehicle includes a driver-operable child safety locking arrangement for rear passenger doors that disables interior door release handles. A separate unlocking arrangement is provided to temporarily override the child safety locking arrangement to allow opening of the rear passenger doors by their interior handles. The override, unlocking arrangement is operable by a driver and requires the simultaneous operation of the rear passenger door handle. The child safety locking arrangement is automatically reset upon release of the rear passenger door handle, without requiring any further action by the driver.

### REFERENCE TO RELATED APPLICATION

This application claims priority to Great Britain Patent Application No. 0715710.0 filed Aug. 11, 2007.

### BACKGROUND OF THE INVENTION

This invention relates generally to a vehicle door latch system.

Typically, child safety arrangements are provided for rear doors of passenger vehicle compartments of a vehicle to ensure that children, for example, travelling in the rear of the vehicle are not able to open the door from inside the passenger vehicle compartment. Thus, when a child safety lock function is switched on, operation of an interior door release handle does not unlatch a latch, and hence an associated door remains closed.

In older vehicles, this function is affected by a mechanical mechanism, which is activated by moving a button or rotating a shaft accessible at a shut face of the door. In more modern vehicles, this function is executed by an electrical control button situated in a front compartment of the vehicle and accessible to a driver, but not to rear passengers. Thus, the driver, or sometimes a front seat passenger, can operate a child safety lock on the rear passenger doors by a button i.e., the child safety status of rear latches can be changed between child safety on and child safety off by operation of the button. Irrespective of the status of the child safety lock, the vehicle door may or may not be opened by operation of an external door handle if the door is unlocked or locked, respectively.

### SUMMARY OF THE INVENTION

The present invention provides an improved vehicle door latch system.

In accordance with one aspect of the present invention, there is provided a vehicle door latch system including a door latch, an inside door handle, and a child safety arrangement. The child safety arrangement has a child safety on status such that operation of the inside door handle does not unlatch the door latch and a child safety off status such that operation of the inside door handle opens the door latch. The child safety arrangement is selectively switchable between the child safety on status and the child safety off status by a first switch. With the child safety arrangement switched to the child safety on status by the first switch, the child safety arrangement is selectively switchable between the child safety on status and the child safety off status by a second switch.

Thus, in accordance with the present invention, the vehicle door latch system is such that the child safety status of the door can be left on at all times (by selectively switching the latch status to child safety on by the first switch), and yet can be temporarily overridden (by operation of the second switch) to allow the door to be opened from inside the vehicle.

This overcomes one disadvantage of current child safety locking arrangements and also provides more convenient operation. For example, with conventional child safety locking arrangements, a driver may forget to switch it to the on status or forget to return it to that status after switching it off to allow children to leave the car. On some vehicles, the child safety latch control is hidden in a compartment of the vehicle similar to a fuse compartment, which the driver can open, but would or could, not do so during normal driving. In this case, it is inconvenient for the driver to allow rear passengers to leave the vehicle. The driver must either open the compartment with the child latch control button in it or step out of the vehicle and open the rear door from the outside. By employing the vehicle door latch system of the present invention, the child safety function can be temporarily overridden by pressing a button, for example an unlock button, operated by the driver, while the rear door release handle is being pulled.

The first switch itself may be securely located in the vehicle where access is restricted. Alternatively, the first switch may be located in a more exposed position, such as in a console in a driver's door or between front seats. In the latter case, access to change the first switch can be restricted, by, for example, arranging for the first switch to be operated only by use of a key, or a code.

### BRIEF DESCRIPTION OF THE DRAWINGS

A vehicle door latch system, its fitting to a vehicle, and its method of operation, will now be described, by way of example, with reference to the accompanying drawings, in which:

FIG. 1 is a diagrammatic representation of a latch system according to the present invention; and

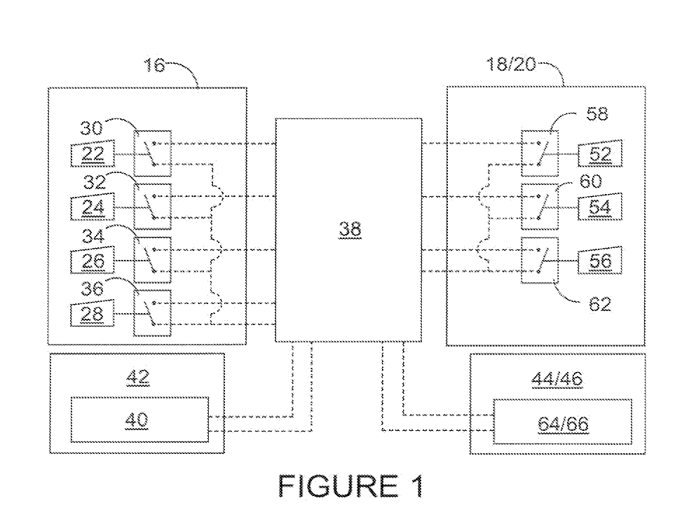

FIG. 2 is a diagrammatic view of a vehicle fitted with the latch system shown in FIG. 1.

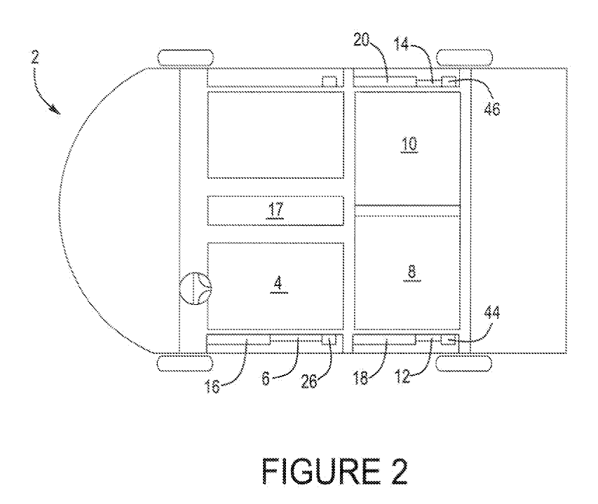

### DETAILED DESCRIPTION OF THE PREFERRED EMBODIMENT

Referring to the drawings, a left-hand drive vehicle 2 has a driver's seat 4 accessed via a driver's door 6 and two rear passenger seats 8 and 10 accessed by associated rear passenger doors 12 and 14. A driver's latch control panel 16 is mounted in the driver's door 6, although it may alternatively be located in a central console 17 of the vehicle 2. A rear passenger door latch control panel 18 and 20 is provided in each of the rear passenger doors 12 and 14, respectively.

The driver's latch control panel 16 includes a lock button 22, an unlock button 24, a handle 26 and a child safety lock button 28 that operate on respective electric switches 30, 32, 34 and 36 that send signals to an electronic control unit (ECU) 38 of the vehicle 2.

When the driver depresses the lock button 22, the electric switch 30 is closed, and this sends a signal to the ECU 38, whose software then instructs the actuators in all of the doors of the vehicle 2 to lock the doors. It will be appreciated that the lock button 22 may be dispensed with and replaced by automatic operation of the electric switch 30 when the ECU 38 senses movement of the vehicle 2 from rest. Depression of the unlock button 24 is subsequently effective via the electric switch 32 and the ECU 38 to unlock all of the doors of the vehicle 2. The handle 26 is the driver's door internal release handle, and, via an electric switch 34 and the ECU 38, operates a release actuator 40 of a driver's door latch 42. The buttons 22 and 24 and the handle 26 are readily accessible by the driver. The electric switches 30, 32 and 34 are all “monostable” switches. That is, the electric switches 30, 32 and 34 are switches which are biased to a first position, and when an operator moves the electric switch 30, 32 and 34 to a second position, it will naturally revert (under the action of the bias) to the first position once released by the operator. In other words, in order to be held in the second position, the electric switches 30, 32 and 34 must be actively held there by the operator; in this case, the driver must keep his finger on the associated buttons 22 and 24 or handle 26.

For the avoidance of doubt, a latch is in a “locked” status when the operation of an outside door handle associated with the latch will not open the associated door. Operation of an inside door handle associated with a locked latch will open the door if the child safety is off, but will not open the door if the child safety is on. A latch is in an “unlocked” status when operation of an outside door handle associated with the latch will open an associated door. Operation of the inside handle associated with an unlocked latch will open the door if the child safety is off, but will not open the door if the child safety is on. Thus, whether a latch is “locked” or “unlocked” can be determined by operating an outside door handle and noting whether the latch remains closed or the latch opens. Whether or not a latch opens upon operation of the inside door handle does not determine whether the latch is locked or unlocked.

The child safety lock button 28 actuates the child lock function via the electric switch 36 and the ECU 38 so as to provide the safety lock for the rear passenger doors 12 and 14, to render their rear passenger door latches 44 and 46 inoperable from inside the vehicle 2. Access to the child safety lock button 28 is restricted, preferably by requiring a key to release it for operation, i.e., for the status of the child safety function to be changed. The key operation may be dispensed with if the child safety lock button 28 is located elsewhere in the vehicle 2, for example in a fuse box where access by the driver or a rear seat passenger would be much more restricted and where it would require a much more positive effort to be operated by the driver. In one embodiment, the electric switch 36 is a bi-stable switch i.e., a switch having two positions, and the electric switch 36 will remain in both positions in the absence of any intervention by the operator. This can be contrasted with the monostable electric switches 30, 32 and 34 as described above.

The rear passenger door latch control panel 18 and 20 on each of the rear passenger doors 12 and 14, respectively, is for operation by the rear passengers. The rear passenger door latch control panels 18 and 20 have rear passenger control buttons 52 and 54 and an inside release handle 56 that operate electric switches 58, 60 and 62, respectively, to pass signals to the ECU 38 of the vehicle 2.

The rear passenger control button 52 is effective to lock the associated rear passenger door 12 or 14, while the rear passenger control button 54 is effective to unlock the associated rear passenger door 12 or 14 via the respective electric switches 58 and 60 and the ECU 38, which passes signals to the respective door latch release actuators 64 and 66 to operate on respective rear passenger door latches 44 and 46. The electric switches 58, 60 and 62 are monostable switches.

In operation, when the driver and rear seat passengers are within the vehicle and the doors are closed, the driver depresses the lock button 22 to lock all the doors of the vehicle 2. This can be done relatively easily because the driver has ready access to the lock button 22. If there are children in the rear passenger seats 8 and 10, the child safety lock button 28 will be actuated (if not previously actuated), thereby rendering the rear passenger door latches 44 and 46 inoperable from inside the vehicle 2. This will require a conscious effort by the driver because access to child safety lock button 28 is restricted. The driver will either have to use a key to actuate the child safety lock button 28, or he will have to open the fuse box to gain access to the switch, for example.

When the driver subsequently wishes to allow one or both of the rear seat passengers to leave the vehicle 2 while he remains in the driver's seat 4, the driver can depress the unlock button 24 while at the same time instructing the rear passenger to operate the respective inside release handle 56. This combined simultaneous operation will then be effective to override the child safety locking function of the child safety lock button 28 and will allow the associated rear passenger door 12 or 14 to be opened from inside the vehicle 2.

Once the rear passenger door latch 44 and 46 has been opened, the passenger will naturally release the inside release handle 56, whereupon the electric switch 62 will revert to its stable position (being a monostable switch). The child safety locking arrangement is automatically reset by the ECU 38. Furthermore, once the child has exited the vehicle 2, the driver will naturally release the unlock button 24, which again ensures that the child safety locking arrangement is automatically reset by the ECU 38.

The following table summarizes the effects of actuating the unlock button 24 and the inside release handle 56 while the child safety lock button 28 is in its child safety on position.

| Unlock button 24 | Inside release handle 56 | Child Safety Status |
|---|---|---|
| Depressed | actuated | Off |
| Released | actuated | On |
| Depressed | released | On |
| Released | released | On |

It will be appreciated, therefore, that a single operation of the child safety lock button 28 is effective to provide additional security for rear seat passengers by disabling the inside release handles 56 of the rear passenger compartment, while the system also allows for convenient operation of a temporary override of the safety locking arrangement. Furthermore, the temporary override is such that no manual re-setting of the safety locking arrangement is required.

Clearly, when the child safety lock button 28 is in its child safety off position, then the table above does not apply, and the child safety status of the rear doors is always off.

Although the description has been in respect of operation of the vehicle door lock system by a driver with respect to two side rear doors of the vehicle 2, it will be appreciated that with proper siting of the driver's latch control panel 16, for example on a center console of the vehicle 2, the locking and override of the safety arrangement may be effected by a passenger in a front compartment of the vehicle 2.

Furthermore, the vehicle 2 may be provided with more than two doors to the rear of the driver, either as further side doors or as rear doors of the vehicle 2, and those other doors may also be fitted with the lock system as described above.

It will be appreciated that the child safety lock button 28 and the electric switch 36 (known as a first switch) can be selectively operated to switch between a child safety on status and the child safety off status. With the child safety arrangement switched to the child safety on status by the child safety lock button 28, the child safety arrangement can nevertheless be selectively switchable to the child safety off status by a second switch, in the above example by simultaneously depressing the unlock button 24 and actuating the inside release handle 56. In further embodiments, the second switch could be a single switch. For example, in an alternative embodiment, by depressing the unlock button 24 and hence closing the electric switch 32, the child safety status could be changed to child safety off independently of whether or not the inside release handle 56 is operated. In a further alternative embodiment, rather than the unlock button 24 and the electric switch 32 acting to change the status to child safety off, the lock button 22 and the electric switch 30 could perform this function. The applicant is the first to realize that switches which are normally provided on a vehicle, such as switches normally associated with locking and unlocking of the doors, can additionally be used to signal a requirement to temporarily override the child safety on status of a rear door or the like. However, in further embodiments, a separate switch dedicated solely to temporarily overriding the child safety on status of an associated door could be provided. Such a dedicated switch may have a stable position and an unstable position; for example, the switch may be monostable.

The buttons 22 and 24 have been shown as being associated with separate electric switches 30 and 32. However, in a further embodiment, a single button (typically a rocking button) may be provided to lock the latch if rocked one way and unlock the latch if rocked the other way. Typically, such a button will have an unstable lock position and an unstable unlocked position between which is situated a stable neutral position. In such an embodiment, the child safety on status could be temporarily overridden by holding the switch in the locked position and/or by holding the switch in the unlocked position.

The electric switch 36 has been described as a bi-stable switch such that in one position, the child safety of the rear doors is off and in the other position, the child safety of the rear doors is on, subject to being temporarily overridden as described above. However, in further embodiments, the electric switch 36 could be a monostable switch which acts to signal a change in child safety status. Under such circumstances, if the child safety is off, then operating and releasing the electric switch 36 will signal to the ECU 38 to change the general status to child safety on. A further operation of the electric switch 36 will signal the ECU 38 to change the general status to child safety off. As with the embodiments described above, where the electric switch 36 is a monostable switch and where it has been operated to signal a change from child safety off to child safety on, then the child safety on status can be temporarily overridden as described above.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A vehicle door latch system comprising:
a door latch;
an inside door handle;
a child safety arrangement having a child safety on status such that operation of the inside door handle does not unlatch the door latch, and a child safety off status such that operation of the inside door handle opens the door latch, the child safety arrangement being selectively switchable between the child safety on status and the child safety off status by a first switch, and with the child safety arrangement switched to the child safety on status by the first switch, the child safety arrangement is selectively switchable between the child safety on status and the child safety off status by a second switch, wherein the second switch is one of a door unlock switch and a door lock switch.

2. The vehicle door latch system as defined in claim 1 wherein the first switch has a first stable position and a second stable position.

3. The vehicle door latch system as defined in claim 2 wherein the first switch is bi-stable.

4. The vehicle door latch system as defined in claim 1 wherein the first switch has a stable position and an unstable position.

5. The vehicle door latch system as defined in claim 4 wherein the first switch is monostable.

6. The vehicle door latch system as defined in claim 1 wherein the second switch has a stable position and an unstable position, and with the second switch in the unstable position, the child safety arrangement is selectively switched to the child safety off status.

7. The vehicle door latch system as defined in claim 6 wherein the second switch is monostable.

8. The vehicle door latch system as defined in claim 6 wherein the second switch has a further unstable position.

9. The vehicle door latch system as defined in claim 8 wherein the second switch is a door unlock switch and the further unstable position operates to lock the door latch.

10. The vehicle door latch system as defined in claim 8 wherein the second switch is a door lock switch and the further unstable position acts to unlock the door latch.

11. The vehicle door latch system as defined in claim 1 wherein the second switch operates electrically.

12. The vehicle door latch system as defined in claim 1 wherein the door latch switches to the child safety off status only upon simultaneous operation of the second switch and a door handle, and releasing of the door handle causes the child safety locking arrangement to automatically reset to the child safety on status.
